(19) United States
(12) Patent Application Publication
(10) Pub. No.: US 2026/0164068 A1
(43) Pub. Date: Jun. 11, 2026

(54) SERVER, METHOD AND COMPUTER PROGRAM

(71) Applicant: 17LIVE Japan INC., Tokyo (JP)

(72) Inventors: Bao-Min CHANG, Taipei City (TW); Yu-Jay KAO, Taipei City (TW); Guan-Hong LIU, Taipei City (TW); Ching-Jan WANG, Taipei City (TW); Yung-Chi HSU, Taipei City (TW)

(21) Appl. No.: 19/180,905

(22) Filed: Apr. 16, 2025

(30) Foreign Application Priority Data
Apr. 19, 2024 (JP) 2024-068625

(51) Int. Cl. H04N 21/2187; H04N 21/4784; H04N 21/845

(52) U.S. Cl. CPC H04N 21/2187; H04N 21/4784; H04N 21/8456

(57) ABSTRACT

A server comprising a circuitry, wherein the circuitry is configured to perform: receiving, from a user, an instruction to use a gift for a streamer before a live streaming of the streamer; and causing an output unit to output an effect and points corresponding to the use of the gift by the user while the streamer is in the live streaming. According to the present disclosure, the viewers may have more options to support the livestreamer. Moreover, the livestreamers may feel positively surprised when receiving the schedule gift in the live streaming. Therefore, the user experience may be improved.

### CROSS-REFERENCE TO RELATED APPLICATIONS

This application is based on and claims the benefit of priority from Japanese Patent Application Serial No. 2024-068625 (filed on Apr. 19, 2024), the contents of which are hereby incorporated by reference in their entirety.

### BACKGROUND OF THE DISCLOSURE

### Technical Field

This disclosure relates to information and communication technology, and in particular, to a server, method and computer program in a live streaming.

### Description of the Related Art

Some APPs or platforms provide live streaming service for livestreamers and viewers to interact with each other. The livestreamers may have a performance to cheer up the viewer and the viewer may send gifts to support the livestreamers.

If viewers would like to support the livestreamer, they have to make it to the live streaming and send gifts to support the livestreamers. Therefore, it requires the livestreamer to broadcast at an appropriate time so that the viewers may give their support to the livestreamer.

However, if viewers could not make it, they lose the chance to enjoy the live streaming and the livestreamer may not be able to receive support from the viewers. This may lead to poor user experience. Therefore, how to improve the user experience is very important.

[Patent Document 1]: JP7272570B1

### SUMMARY OF THE INVENTION

An embodiment of subject application relates to a server comprising a circuitry, wherein the circuitry is configured to perform: receiving, from a user, an instruction to use a gift for a streamer before a live streaming of the streamer; and causing an output unit to output an effect and points corresponding to the use of the gift by the user while the streamer is in the live streaming.

Another embodiment of subject application relates to a method, comprising: receiving, from a user, an instruction to use a gift for a streamer before a live streaming of the streamer; and causing an output unit to output an effect and points corresponding to the use of the gift by the user while the streamer is in the live streaming.

Another embodiment of subject application relates to a non-transitory computer-readable medium including program instructions, that when executed by one or more processors, cause the one or more processors to execute: receiving, from a user, an instruction to use a gift for a streamer before a live streaming of the streamer; and causing an output unit to output an effect and points corresponding to the use of the gift by the user while the streamer is in the live streaming.

According to the embodiments, the viewers may have more options to support the livestreamer. Moreover, the livestreamers may feel positively surprised when receiving the schedule gift in the live streaming. Therefore, the user experience may be improved.

### BRIEF DESCRIPTION OF THE DRAWINGS

FIG. 1 is a schematic configuration of a live streaming system 1 according to some embodiments of subject application;

FIG. 2 is a schematic block diagram of the user terminal 20 according to some embodiments of subject application;

FIG. 3 is a schematic block diagram of the server 10 according to some embodiments of subject application;

FIG. 4 shows an exemplary data structure of the stream DB 320 of FIG. 3;

FIG. 5 shows an exemplary data structure of the user DB 322 of FIG. 3;

FIG. 6 shows an exemplary data structure of the schedule DB 324 of FIG. 3;

FIG. 7 shows an exemplary data structure of the gift DB 326 of FIG. 3;

FIG. 8 shows an exemplary data structure of the subscription DB 328 of FIG. 3;

FIG. 9 is an exemplary data structure of the subscription look-up table 330 of FIG. 3;

FIG. 10-FIG. 15 are exemplary screen images of a live streaming room screen 600 shown on the display of the livestreamer user terminal 20 or the viewer user terminal 30;

FIG. 16 is a flowchart showing steps of an application activation process on the user terminals 20 and 30;

FIG. 17 is exemplary functional configuration of the live streaming system 1 according to some embodiments of subject application;

FIG. 18 is an exemplary hardware configuration of the information processing device according to some embodiments of subject application.

### DETAILED DESCRIPTION

Hereinafter, the identical or similar components, members, procedures or signals shown in each drawing are referred to with like numerals in all the drawings, and thereby an overlapping description is appropriately omitted. Additionally, a portion of a member which is not important in the explanation of each drawing is omitted.

The live streaming system 1 according to some embodiments of subject application provides enhancement among the users to communicate and interact smoothly. More specifically, it entertains the viewers and livestreamers in a technical way.

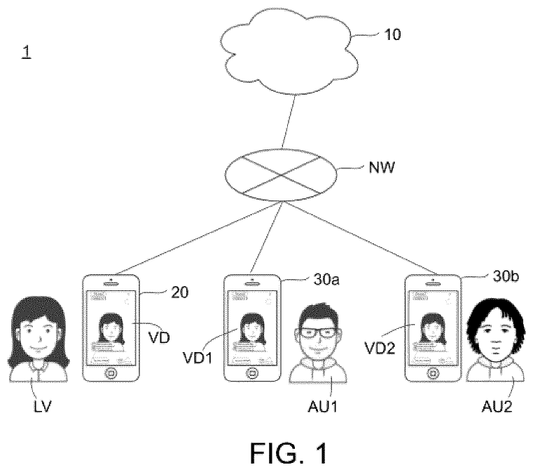

FIG. 1 shows a schematic configuration of a live streaming system 1 according to some embodiments of subject application. The live streaming system 1 provides a live streaming service for the streaming livestreamer (may also be referred as liver, streamer or distributor) LV and viewer (may also be referred as audience) AU (AU1, AU2 . . . ) to interact mutually in real time. As shown in FIG. 1, the live streaming system 1 may include a server 10, a user terminal 20 and a user terminal 30 (30a, 30 b . . . ). The user terminal 20 may be a livestreamer and the user terminal 30 may be a viewer. In some embodiments, the livestreamers and viewers may be referred to as the user. The server 10 may include one or a plurality of information processing devices connected via network NW. The user terminal 20 and 30 may be, for example, a portable terminal such as the smartphone, tablet, laptop PC, recorder, mobile game console, wearable device or the like, or the stationary computer such as desktop PC. The server 10, user terminal 20 and user terminal 30 may be communicably connected by any type of wire or wireless network NW.

The live streaming system 1 is involved in the livestreamer LV, the viewer AU, and APP provider (not shown), who provides the server 10. The livestreamer LV may record his/her own contents such as songs, talks, performance, game streaming or the like by his/her own user terminal 20 and upload to the server 10 and be the one who distributes contents in real time. In some embodiments, the livestreamer LV may interact with the viewer AU via the live streaming.

The APP provider may provide a platform for the contents to go on live streaming in the server 10. In some embodiments, the APP provider may be the media or manager to manage the real time communication between the livestreamer LV and viewer AU. The viewer AU may access the platform by the user terminal 30 to select and watch the contents he/she would like to watch. The viewer AU may perform operations to interact with the livestreamer, such as commenting or cheering the livestreamer, by the user terminal 30. The livestreamer, who provides the contents, may respond to the comment or cheer. The response of the livestreamer may be transmitted to the viewer AU by video and/or audio or the like. Therefore, a mutual communication among the livestreamer and viewer may be accomplished.

The “live streaming” in this specification may be referred to as the data transmission which enables the contents the livestreamer LV recorded by the user terminal 20 to be substantially reproduced and watched by the viewer AU via the user terminal 30, In some embodiments, the “live streaming” may also refer to the streaming which is accomplished by the above data transmission. The live streaming may be accomplished by the well-known live streaming technology such as HTTP Live Streaming, Common Media Application Format, Web Real-Time Communications, Real-Time Messaging Protocol, MPEG DASH or the like. The live streaming may further include the embodiment that the viewer AU may reproduce or watch the contents with specific delay while the livestreamer is recording the contents. Regarding the magnitude of the delay, it should be at least small enough to enable the livestreamer LV and the viewer AU to communicate. However, live streaming is different from so-called on-demand streaming. More specifically, the on-demand streaming may be referred to as storing all data, which records the contents, in the server and then providing the data from the server to the user at random timing according to the user's request.

The “streaming data” in this specification may be referred to as the data includes image data or voice data. More specifically, the image data (may be referred to as video data) may be generated by the image pickup feature of the user terminal 20 and 30. The voice data (may be referred to as audio data) may be generated by the audio input feature of the user terminal 20 and 30. The streaming data may be reproduced by the user terminal 20 30, so that the contents relating to users may be available for watching. In some embodiments, during the period from the streaming data being generated by the user terminal 20 of the livestreamer to being reproduced by the user terminal 30 of the viewer, the processing of changing format, size or specification of the data, such as compression, extension, encoding, decoding, transcoding or the like, is predictable. Before and after this kind of processing, the contents (such as video and audio) are substantially unchanged, so it is described in the current embodiments of the present disclosure that the streaming data before being processed is the same as that after being processed. In other words, if the streaming data is generated by the user terminal 20 of the livestreamer and reproduced by the user terminal 30 of the viewer via the server 10, the streaming data generated by the user terminal 20 of the livestreamer, the streaming data passed through the server 10 and the streaming data received and reproduced by the by the user terminal 30 of the viewer are all the same streaming data.

As shown in FIG. 1, the livestreamer LV is providing the live streaming. The user terminal 20 of the livestreamer generates the streaming data by recording his/her video and/or audio, and transmits to the server 10 via the network NW. At the same time, the user terminal 20 may display the video VD on the display of the user terminal 20 to check the streaming contents of the livestreamer LV.

The viewer AU1, AU2 of the user terminal 30a, 30b, who request the platform to provide the live streaming of the livestreamer, may receive streaming data corresponding to the live streaming via the network NW and reproduce the received streaming data to display the video VD1, VD2 on the display and output the audio from a speaker or the like. The video VD1, VD2 displayed on the user terminal 30a, 30b respectively may be substantially the same as the video VD recorded by the user terminal 20 of the livestreamer LV, and the audio outputted from the terminal 30a, 30b may also be substantially the same as the audio recorded by the user terminal 20 of the livestreamer LV.

The recording at the user terminal 20 of the livestreamer may be simultaneous with the reproducing of the streaming data at the user terminal 30a, 30b of the viewer AU1, AU2. If a viewer AU1 inputs a comment on the contents of the livestreamer LV into the user terminal 30a, the server 10 will display the comment on the user terminal 20 of the livestreamer in real time, and also display on the user terminal 30a, 30b of the viewer AU1, AU2 respectively. If the livestreamer LV responds to the comment, the response may be outputted as the text, image, video or audio from the terminal 30a, 30b of the viewer AU1, AU2, so that the communication of the livestreamer LV and viewer LV may be realized. Therefore, the live streaming system may realize the live streaming of two-way communication.

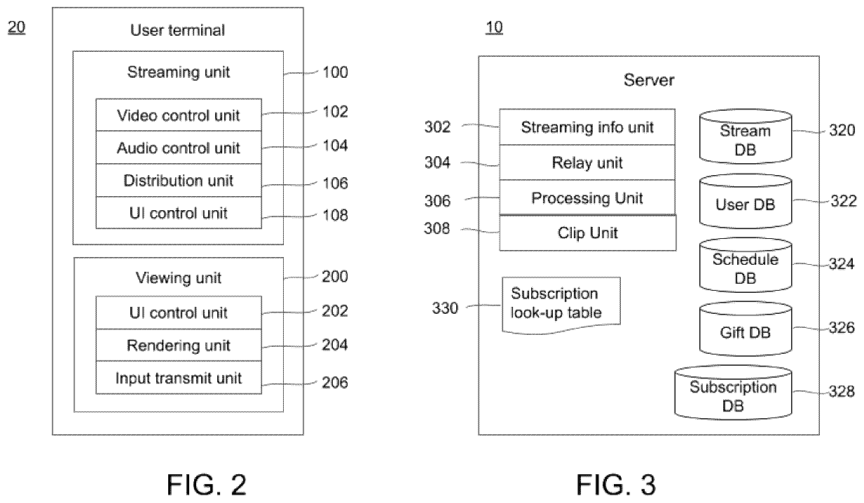

FIG. 2 is a block diagram showing a function and configuration of the user terminal 20 in FIG. 1 according to the embodiment of the present disclosure. The user terminal 30 has the similar function and configuration of the user terminal 20. The blocks depicted in the block diagram of this specification are implemented in hardware such as devices like a CPU of a computer or mechanical components, and in software such as a computer program depicts functional blocks implemented by the cooperation of these elements. Therefore, it will be understood by those skilled in the art that the functional blocks may be implemented in a variety of manners by a combination of hardware and software.

The livestreamer LV and viewer AU may download and install the live streaming application (live streaming APP) of the present disclosure to the user terminal 20 and 30 from the download site via network NW. Or the live streaming APP may be pre-installed in the user terminal 20 and 30. By the execution of the live streaming by the user terminal 20 and 30, the user terminals 20 and 30 may communicate with the server 10 via the network NW to realize a plurality of functions. The functions realized by the execution of the live streaming APP by the user terminal 20 and 30 (More specifically, the processor such as CPU) is described below as the functions of the user terminal 20 and 30. These functions are basically the functions that the live streaming APP makes the user terminals 20 and 30 realize. In some embodiments, these functions may also be realized by transmitting from the server 10 to the web browser of the user terminal 20 and 30 via network NW and be executed by the computer program of the web browser. The computer program may be written in the programming language such as HTML (Hyper Text Markup Language) or the like.

The user terminal 20 includes streaming unit 100 and viewing unit 200. In some embodiments, the streaming unit 100 is configured to record the audio and/or video data of the user and generate streaming data to transmit to the server 10. The viewing unit 200 is configured to receive and reproduce streaming data from server 10. In some embodiments, a user may activate the streaming unit 100 when broadcasting or activate the viewing unit 200 when watching streaming respectively. In some embodiments, the user terminal who is activating the streaming unit 100 may be referred to as a livestreamer or be referred to as the user terminal 20 which generates the streaming data. The user terminal who is activating the viewing unit 200 may be referred to as a viewer or be referred to as the user terminal 30 which reproduces the streaming data.

The streaming unit 100 may include video control unit 102, audio control unit 104, distribution unit 106 and UI control unit 108. The video control unit 102 may be connected to a camera (not shown) and the video is controlled by the camera. The video control unit 102 may obtain the video data from the camera. The audio control unit 104 may be connected to a microphone (not shown) and the audio is controlled by the microphone. The audio control unit 104 may obtain the audio data from the microphone.

The distribution unit 106 receives streaming data, which includes video data from the video control unit 102 and audio data from the audio control unit 104, and transmits to the server 10 via network NW. In some embodiments, the distribution unit 106 transmits the streaming data in real-time. In other words, the generation of the streaming data from the video control unit 102 and audio control unit 104, and the distribution of the distribution unit 106 is performed simultaneously.

UI control unit 108 controls the UI for the livestreamer. The UI control unit 108 is connected to a display (not shown) and is configured to generate the streaming data to whom the distribution unit 106 transmits, reproduces and displays the streaming data on the display. The UI control unit 108 shows the object for operating or the object for instruction-receiving on the display and is configured to receive the tap input from the livestreamer.

The viewing unit 200 may include UI control unit 202, rendering unit 204 and input transmit unit 206. The viewing unit 200 is configured to receive streaming data from server 10 via network NW. The UI control unit 202 controls the UI for the viewer. The UI control unit 202 is connected to a display (not shown) and/or speaker (not shown) and is configured to display the video on the display and output the audio from the speaker by reproducing the streaming data. In some embodiments, Outputting the video on the display and audio from the speaker may be referred to as “reproducing the streaming data”. The UI control unit 202 may be connected to an input unit such as touch panel, keyboard or display or the like to obtain input from the users.

The rendering unit 204 may be configured to render the streaming data from the server 10 and the frame image. The frame image may include user interface objects for receiving input from the user, the comments inputted by the viewers and the data received from the server 10. The input transmit unit 206 is configured to receive the user input from the UI control unit 202 and transmit to the server 10 via the network NW.

In some embodiments, the user input may be clicking an object on the screen of the user terminal 20 or 30 such as selecting a live stream, entering a comment, sending a gift, following or unfollowing an user, voting in an event, gaming or the like. For example, the input transmit unit 206 may generate gift information and transmit to server 10 via the internet NW if the user terminal 30 of the viewer clicks a gift object on the screen in order to send a gift to the livestreamer.

In some embodiments, the user terminal 20 may include a terminal side gift DB (not shown). The terminal side gift DB is configured to store the gift information of the user terminal 20 or 30. The terminal side gift DB may include gift ID, icon ID, effect data ID and final update date. The gift ID may identify the gift. The Icon ID may be the icon data of the gift object. The effect data ID may identify the data realizing the effect corresponding to the gift. The final update date may identify the final update date of the gift.

In some embodiments, the viewer may download the gift in advance or download the gift when sending gifts. In some embodiments, gift information may be downloaded and stored in the terminal side gift DB in advance. In some embodiments, the terminal side gift DB may include the gift list corresponding to the gift list provided by the server 10. In some embodiments, the gift list in the terminal side gift DB may be synchronized with the server 10 periodically or by an operation from the user.

FIG. 3 is a schematic block diagram of the server 10 according to some embodiments of the subject application. The server 10 may include streaming info unit 302, relay unit 304, processing unit 306, clip unit 308, stream DB 320, user DB 322, schedule DB 324, gift DB 326, subscription DB 328 and subscription look-up table 330.

The streaming info unit 302 receives the request of live streaming from the user terminal 20 of the livestreamer via the network NW. Once receiving the request, the streaming info unit 302 registers the information of the live streaming on the stream DB 320. In some embodiments, the information of the live streaming may be the stream ID of the live streaming and/or the livestreamer ID of the livestreamer corresponding to the live streaming.

Once receiving the request of providing the information of the live streaming from the viewing unit 200 of the user terminal 30 from the viewer via the network NW, the streaming info unit 302 refers to the stream DB 320 and generates a list of the available live streaming.

The streaming info unit 302 then transmits the list to the user terminal 30 via the network NW. The UI control unit 202 of the user terminal 30 generates a live streaming selection screen according to the list and displays the list on the display of the user terminal 30.

Once the input transmit unit 206 of the user terminal 30 receives the selection of the live streaming from the viewer on the live streaming selection screen, it generates the streaming request including the stream ID of the selected live streaming and transmits to the server 10 via the network. The streaming info unit 302 may start to provide the live streaming, which is specified by the stream ID in the streaming request, to the user terminal 30. The streaming info unit 302 may update the stream DB 320 to add the viewer's viewer ID of the user terminal 30 to the livestreamer ID of the stream ID.

The relay unit 304 may relay the transmission of the live streaming from the user terminal 20 of the livestreamer to the user terminal 30 of the viewer in the live streaming started by the streaming info unit 302. The relay unit 304 may receive the signal, which indicates the user input from the viewer, from the input transmit unit 206 while the streaming data is reproducing. The signal indicating the user input may be the object-designated signal which indicates the designation of the object shown on the display of the user terminal 30. The object-designated signal may include the viewer ID of the viewer, the livestreamer ID of the livestreamer, who delivers the live streaming the viewer is viewing, and object ID specified by the object. If the object is a gift or the like, the object ID may be the gift ID or the like. Similarly, the relay unit 304 may receive the signal indicating the user input of the livestreamer, for example the object-designated signal, from the streaming unit 100 of the user terminal 20 while the streaming data is reproducing.

In some embodiments, the server 10 may further include gift info unit (not shown) and gift processing unit (not shown). The gift info unit provides information on gifts to the corresponding livestreamer and viewers. The gift info unit transmits, to the livestreamer, the gift information for the terminal in response to a request from the user terminals. The gift info unit obtains, from the gift DB 326, the effect data corresponding to the gift ID included in the gift information signal that has been received by the relay unit 304. The gift info unit transmits the obtained effect data to the other user terminals 20 and 30 as a response to the gift sending request signal.

The gift processing unit updates the user DB 322 so as to update the points of the livestreamer and the viewer depending on the points of the gift identified by the gift ID included in the gift usage signal. Specifically, the gift processing unit refers to the gift DB 326 to specify the points to be granted for the gift ID included in the received gift usage signal. The gift processing unit then updates the user DB 322 to add the determined points to the points of the livestreamer ID included in the gift usage signal. In some embodiments, the gift processing unit may also update the user DB 322 to subtract the determined points from the points of the viewer ID included in the gift usage signal.

The clip unit 308 may be configured to process the clip contents. In some embodiments, the clip unit 308 may retrieve streaming data and interaction data for rendering and recording. Here, the interaction data may be any possible interactive information in the live streaming room such as message, comment, gift, following, gaming, VIP online notification, entrance animation or the like.

In some embodiments, the clip unit 308 may store the clip contents in a storage and a database. In some embodiments, the clip unit 308 may also generate a link to the clip contents. In some embodiments, the clip contents may be kept forever or be deleted after a specific period such as 7 days, 14 days or the like. In some embodiments, the setting of the clip contents may be determined flexibly according to the practical need.

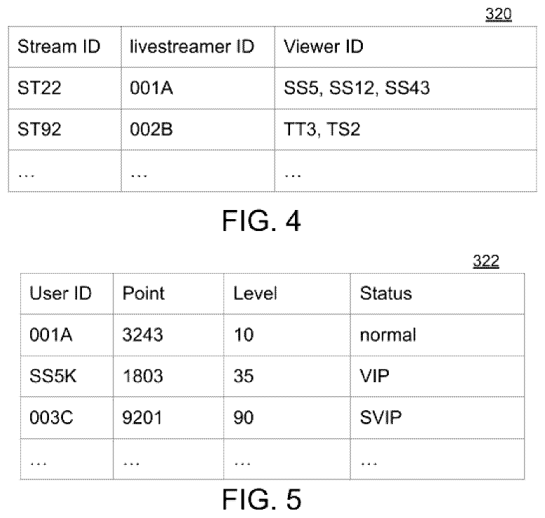

FIG. 4 shows an exemplary data structure of the stream DB 320 of FIG. 3. The stream DB 320 holds information regarding a live stream currently taking place. The stream DB 320 stores a stream ID for identifying a live-stream on a live distribution platform provided by the live streaming system 1, a livestreamer ID for identifying the livestreamer who provides the live stream, and a viewer ID for identifying a viewer of the live stream, in association with each other.

FIG. 5 shows an exemplary data structure of the user DB 322 of FIG. 3. The user DB 322 holds information regarding users. The user DB 322 stores a user ID for identifying a user, points for identifying the points the user accumulates, level for identifying the level of the user and status for identifying the status of the user in association with each other. The point is the electronic value circulated within the live streaming platform. The level may be an indicator of the amount of user activity or engagement on the live streaming platform. The status may be an identity or membership status of the user on the live streaming platform.

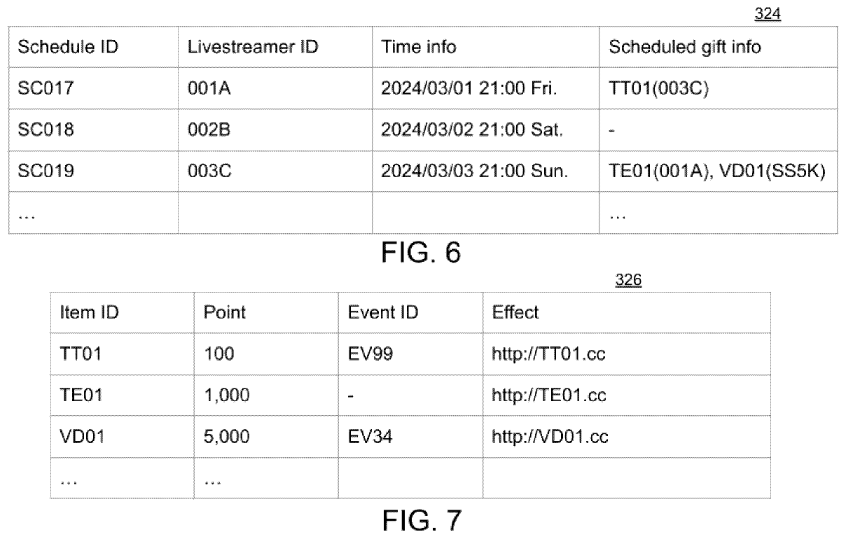

FIG. 6 shows an exemplary data structure of the schedule DB 324 of FIG. 3. The schedule DB 324 holds information regarding a broadcasting schedule. The schedule DB 324 stores a schedule ID for identifying a broadcasting schedule, a livestreamer ID for identifying the livestreamer who generates or starts the broadcasting, a time info for identifying the time information on the broadcasting schedule and a schedule gift info for identifying information on the schedule gift corresponding to the broadcasting schedule, in association with each other.

In some embodiments, the schedule may be generated by the livestreamer, viewer, Server 10 or the like. For example, the livestreamer may generate a broadcasting schedule by himself or herself, or with the help of the other users or the like. Server 10 may also generate a broadcast schedule according to an event held in the live streaming platform. In some embodiments, the schedule gift info may include, for example, the schedule gift ID, the sender, the number of gifts or the like. In some embodiments, the schedule gift may be a specific type of gift or be any possible general gift. In some embodiments, the schedule gift info may also be a type of subscription to the livestreamer or the like and would be described later.

FIG. 7 shows an exemplary data structure of the gift DB 326 of FIG. 3. The gift DB 324 maintains information on gifts that can be used by the viewer in the live streaming. The gift DB 324 stores a gift item ID for identifying a gift, the amount of points that the viewer spends in order to send the gift to the streamer, the event ID for identifying the event the gift is corresponding to, and the effect data for the gift item, in association with each other.

The viewer can give the gift to the streamer by paying the equivalent value points for a desired gift while watching the live streaming. The payment of such equivalent value points can be made by an appropriate electronic means, for example, the viewer can pay the equivalent value points to the administrator. Alternatively, bank transfers or credit card payments can also be used. The relationship between awarded points and equivalent value points can be set arbitrarily by the administrator.

A gift is electronic data with the following characteristics:
It can be purchased in exchange for the points (later described in detail) or can be given for free.
It can be given by a viewer to a streamer.—Giving a gift to a streamer is referred to as using the gift or throwing the gift.
Some gifts may be purchased and used at the same time, and some gifts may be purchased or given and then used at any time later by the purchaser or recipient viewer.
When a viewer gives a gift to a streamer, the streamer is awarded the amount of points corresponding to the gift and an effect associated with the gift is exerted. For example, an effect corresponding to the gift will appear on the live streaming screen.

The effect is a visual or auditory or tactile effect (e.g., vibration) or a combination thereof that characterizes a gift. Examples of the visual effect include animation, images, and flashing/blinking. Examples of the auditory effect include sound effects and voice. The effect data is data for realizing such an effect on the user terminal 20, and the user terminal 20 realizes such an effect by processing the effect data. Since the technique for realizing the effect data itself is known, it will not be hereunder described in detail.

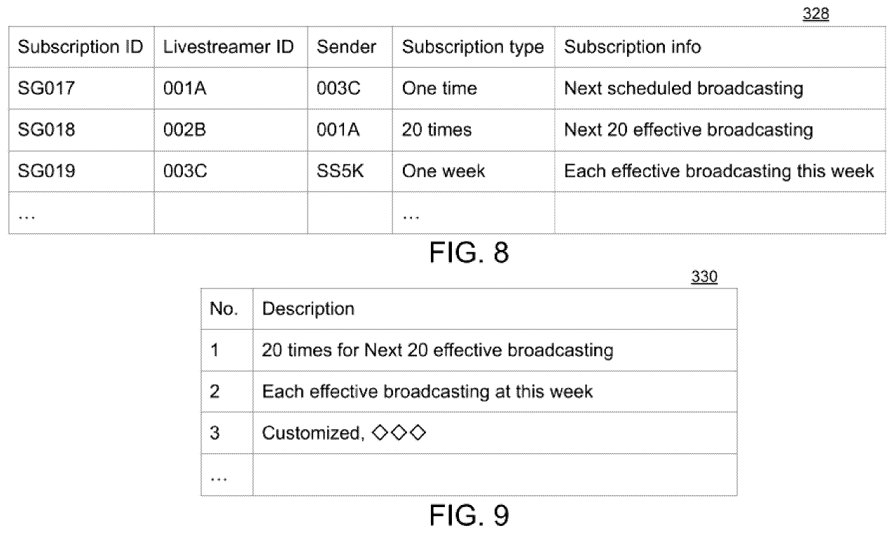

FIG. 8 shows an exemplary data structure of the subscription DB 328 of FIG. 3. The subscription DB 328 holds information regarding a subscription to the schedule gift. The subscription DB 328 stores a subscription ID for identifying a subscription of the schedule gift to a livestreamer, a livestreamer ID for identifying the livestreamer who receives the schedule gift, a sender for identifying the user who sends the schedule gift, a subscription type for identifying the type of subscription and a subscription info for identifying information on subscription, in association with each other.

In some embodiments, a look-up table such as the subscription look-up table 330 shown in FIG. 9 may be provided. The subscription may include a setting of the schedule gift subscription to the live streaming of the livestreamer. The subscription may include a default setting of the schedule gift. In some embodiments, the setting may include, for example, the time, number of times, period, timing or the like. For example, the subscription may be 20 times for the next effective broadcasting. The subscription may also be effective broadcasting at one week or the like. In some embodiments, the subscription may be determined or designed according to the practical need.

In some embodiments, the timing of reflecting the schedule gift on the live streaming room may also be determined flexibly. For example, the timing may be in the beginning of the live streaming, the time point of an effective broadcasting being achieved, by the end of the live streaming, or randomly during the live streaming. In some embodiments, the subscription may also be customized by the users themselves. For example, the user may input their own subscription via any possible input unit such as typing, speaking, uploading or the like. The conversion from input to the customized subscription may be realized by machine learning technology such as LLM, ChatGPT or the like.

FIG. 9 shows an exemplary data structure of the subscription look-up table 330 of FIG. 3. The subscription look-up table 330 may be configured to store the available schedule gift subscription to the livestreamer. As shown in FIG. 9 as an example, the subscription look-up table 330 may include the description of the subscription. The description may be a default setting of a subscription determined by the APP provider, or a customized setting of a subscription determined by the users or the like.

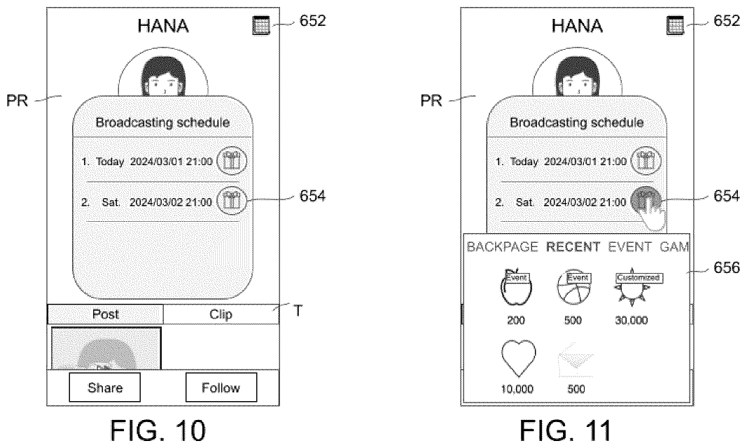

FIG. 10-FIG. 15 are exemplary screen images of a live streaming room screen 600 shown on the display of the livestreamer user terminal 20 or the viewer user terminal 30.

FIG. 10 shows an exemplary profile page of the livestreamer. As shown in FIG. 10, the profile page may include information about the livestreamer, for example, the name, display image, follower information, post or the like.

In some embodiments, the livestreamer may generate a broadcasting schedule at the profile page. The livestreamer may set the next broadcasting schedule, for example, in the profile page. Once the broadcast schedule is generated, viewers may check the information about the broadcast schedule. The viewers may check the broadcasting schedule via a push notification, from the post of the livestreamer or by checking the profile page of the livestreamer. As shown in FIG. 10 as an example, a calendar object 652 may be provided for the livestreamer to generate or the viewers to get access to the broadcasting schedule.

The viewers may check the schedule of the next broadcasting of the livestreamer in the calendar. If the viewers could not make it to the next live streaming of the livestreamer, the viewers may send a schedule gift to the livestreamer in advance. As shown in FIG. 10 and FIG. 11, a gift object 654 may be displayed on the broadcasting schedule. The viewers may send the schedule gift to the livestreamer via clicking the gift object 654.

Once the gift object 654 is clicked, a gift list 656 may be displayed for the viewers to select and send the schedule gift. In some embodiments, the gift object 654 and gift list 656 may be the same as that in the live streaming room or different from that and may be determined flexibly. In some embodiments, the gift items in the gift list 656 may also be the same as that in the live streaming room, or some specific schedule gift may also be provided in the gift list 656.

In some embodiments, the viewers may click the gift items at the gift list 656 to send a schedule gift to the livestreamer. Server 10 may receive information about the schedule gift and store them in the corresponding database such as schedule DB 324 or the like. In some embodiments, any possible gift may be sent to the livestreamer in advance. For example, the event gift, customized gift, general gift, lucky bag gift or the like may be sent.

Here, the lucky bag gift may be a gift to distribute points to the livestreamer and viewers in the live streaming room. The viewers and livestreamer may click the effect of the lucky bag to receive a specific amount of points. The amount may be a random amount or distributed according to the timing of clicking the effect. For example, the one who clicks the effect first may receive half of the points and the following nine viewers may share the rest of the points. In some embodiments, the mechanism of the lucky bag gift may be determined flexibly.

In some embodiments, the lucky bag gift may include the mechanism of gathering viewers to the targeted live streaming room to increase the number of viewers in the live streaming room. For example, a marquee of “there is a lucky bag in the live streaming room” may be displayed, and the viewer may click the marquee to get access to the live streaming room. In some embodiments, if the viewers send the lucky bag gift to the livestreamer in advance, the lucky bag gift may be reflected in the next broadcasting of the livestreamer. According to the embodiments, an amount of viewers may be guided to the live streaming room in the beginning of the broadcasting, and the popularity of the live streaming room may be boosted quickly.

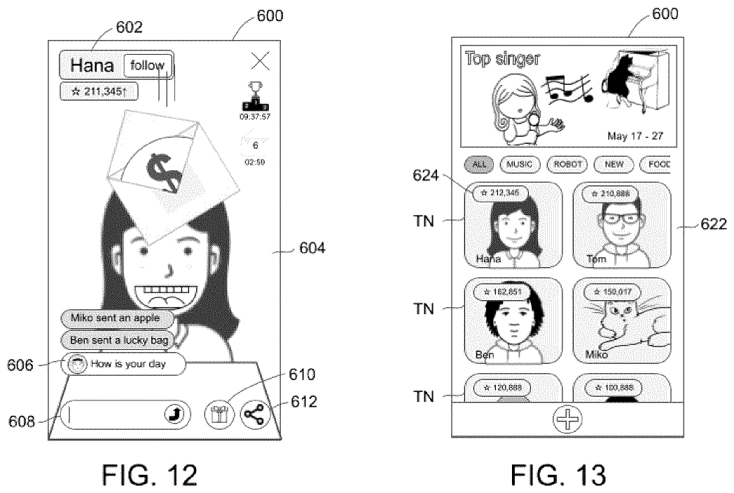

As shown in FIG. 12, once the livestreamer starts the broadcasting or the viewer enters the live streaming room, a live streaming room screen 600 of the livestreamer may be shown on the display. The live streaming room screen 600 may include a livestreamer info object 602, livestreamer image 604, message zone 606, message input box 608, gift object 610, sharing object 612 or the like.

In some embodiments, once the livestreamer starts the broadcasting, the schedule gift may be reflected in the live streaming room. In some embodiments, the popularity of the live streaming room may be calculated according to the interaction in the live streaming room. In some embodiments, the interaction may also include the schedule gift or the like. According to the embodiments, even if the viewers could not make it to the live streaming room, the support from the viewers may also be received during the broadcasting.

In some embodiments, the popularity may be displayed on a thumbnail of the live streaming. As shown in FIG. 13, the user may request server 10 to provide the information of live streaming, and Server 10 may generate a list of the available live streaming. Upon receiving the list, the UI control unit 202 of the user terminal 30 may generate a live streaming selection screen 622 according to the list and display the list on the display of the user terminal 30. In some embodiments, the live streaming selection screen 622 may include a thumbnail TN of each live streaming for the user to select.

In some embodiments, the thumbnail TN of the live streaming may include a popularity mark 624 to indicate the popularity in the live streaming. In some embodiments, the order of the live streaming thumbnail at the live streaming page may be determined according to the popularity of the live streaming room. As shown in FIG. 13, once the livestreamer receives a lot of schedule gifts in the beginning of the broadcasting, the live streaming room may be boosted to a higher or more apparent place in the live streaming page 622. According to the embodiments, the livestreamer may have more chances to expose to different viewers, and the livestreamer may not feel lonely or ignored in the beginning of the broadcasting.

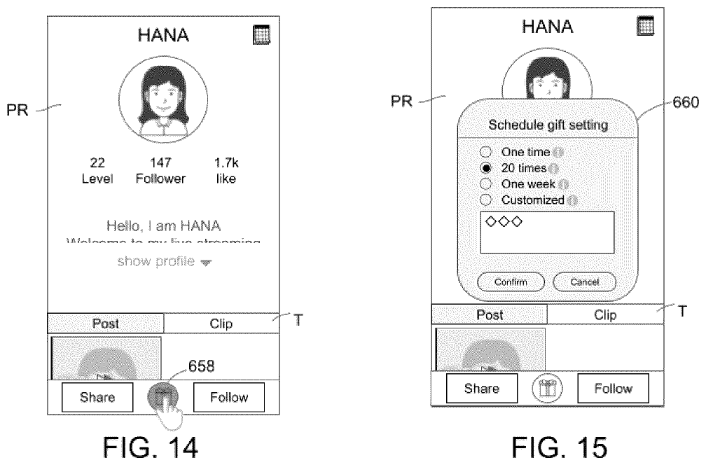

In some embodiments, the schedule gift may also be a subscription to the livestreamer for a specific period or periodically. Besides the broadcasting schedule, the schedule gift subscription object 658 may also be displayed at the profile page PR for the viewers to subscribe to the livestreamer for sending the schedule gift as shown in FIG. 14. In some embodiments, the schedule gift subscription object 658 may also be displayed at the broadcasting setting page or the like and may be determined flexibly.

Once the schedule gift subscription object 658 is clicked, a list of the subscription may be displayed on the screen 600. More specifically, Server 10 may retrieve the available subscription from, for example, the subscription DB 300 and transmit to the user terminals 30 of the viewers for display. The viewers may select the preferred subscription to send schedule gifts to the livestreamer. According to the embodiments, the viewers may have more options to support the livestreamer and the user experience may be improved.

In some embodiments, the subscription may also be customized by the viewers. For example, the viewers may determine the livestreamer, the gift type, number of times, period or the like. FIG. 15 shows an example 660 of the customized subscription. As shown in FIG. 15, an input column may be provided for the viewers to enter the customized subscription. In some embodiments, the input may be fed into a machine learning model to generate the subscription or the like. In some embodiments, any possible means such as form, microphone, upload button or the like may also be provided flexibly.

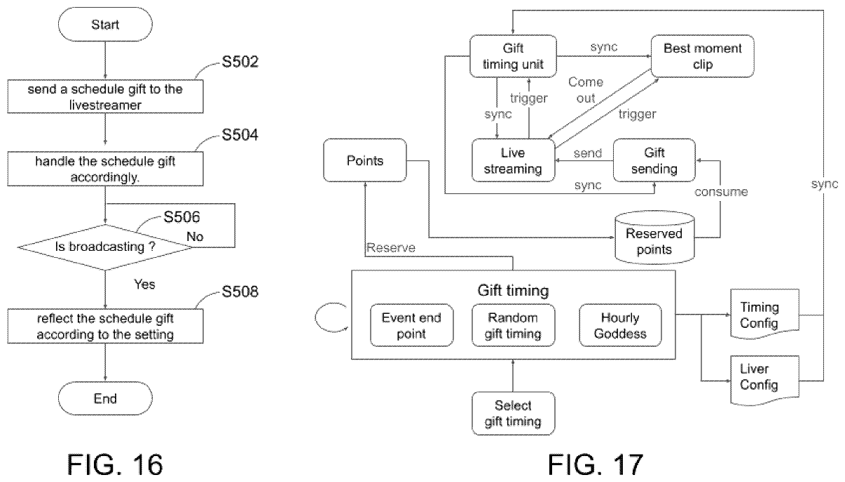

FIG. 16 is a flowchart showing steps of an application activation process on the user terminals 20 and 30. As shown in FIG. 16, the viewers send a schedule gift to the livestreamer (S502). In some embodiments, the schedule gift may be sent via, for example, the livestreamer's broadcasting schedule, the livestreamer's person profile or the like. In some embodiments, the schedule gift may be provided by Server 10 or customized by the viewers.

Server 10 may handle the schedule gift according to the request from the viewers (S504). In some embodiments, Server 10 may refer to the schedule DB 324, gift DB 326, schedule gift look-up table 330 or the like. For example, Server 10 may refer to the schedule DB 324 and gift DB 326 to proceed with the sending of the schedule gift, and further refer to the schedule gift look-up table 330 if the schedule gift is a subscription to the livestreamer.

In some embodiments, if the livestreamer has not started the broadcasting (No in S506), the schedule gift and/or the points may be reserved in Server 10 until the broadcasting from the livestreamer. In some embodiments, the livestreamer may delete the broadcasting schedule, so Server 10 may cancel the schedule gift or move the schedule gift to the next broadcasting schedule or the like. In some embodiments, the viewers may also cancel the schedule gift if the broadcasting schedule is deleted.

Once the livestreamer is broadcasting (Yes in S506), Server 10 may reflect the schedule gift on the live streaming room of the livestreamer according to the setting of the schedule gift (S508). For example, Server 10 may send the schedule gift on the live streaming room once the livestreamer starts the broadcasting. According to the embodiments, the popularity of the live streaming room may be boosted quickly in the beginning of the live streaming room, and more viewers may be attracted and enter the live streaming room to interact with the livestreamer.

In some embodiments, the schedule gift may be reflected on the live streaming room once the livestreamer achieves an effective broadcasting. For example, the livestreamer may receive the schedule gift if the duration of the broadcasting is over a specific period such as 30 minutes or the like. According to the embodiments, it may motivate the livestreamer to keep the broadcasting longer so that the interaction between the livestreamer and the viewers may be improved.

FIG. 17 is an exemplary functional configuration of the live streaming system 1 according to some embodiments of subject application. In some embodiments, the viewers may select a timing for sending the gift. In some embodiments, the timing may also be a time point during a broadcasting from the livestreamer and may be determined flexibly by the viewers. For example, the timing may be the time point in the beginning, during the middle or by the end of an event. In some embodiments, the timing may also be a random time point during the broadcasting so that the livestreamer may be surprised and feel cheerful.

In some embodiments, once the gift and the timing for sending the gift is determined, the points of the gift may be reserved in Server 10. In some embodiments, there may be a corresponding database to record or store the points. In some embodiments, any possible related information such as the points, gift information or the like may also be stored and recorded accordingly.

In some embodiments, once the gift is sent and the gift timing is determined, the related information may be synchronized with the gift timing executor and the gift sending unit. Here, the gift timing executor and the gift sending unit may be the processing unit 306, gift info unit, and gift processing unit or the like in Server 10.

Once the livestreamer starts the live streaming, the status in the live streaming room may be synchronized with the gift timing executor. If there is a timing being triggered, the gift timing executor may synchronize the information with the gift sending unit. The gifting sending unit may retrieve the reserved points and then send the gift item and the points to the livestreamer. In other words, the gift sending unit may consume the points reserved in the corresponding database to send the gift and the points to the livestreamer.

In some embodiments, once the gift is sent to the livestreamer at the gift timing, a corresponding effect to the gift may also be displayed on the screen 600 of the live streaming room. The livestreamer may show his or her gratitude once noticing the gift animation. However, if the sender is not in the live streaming room during that timing, the gratitude from the livestreamer may not be conveyed to the viewers.

In some embodiments, if there is a timing being triggered, the gift timing executor may synchronize the information with the best moment clip unit. Here, the best moment clip unit may be the clip unit 308 or the like in Server 10. In some embodiments, the best moment clip unit may also be triggered and activated once a gift timing is triggered. For example, the moment of the livestreamer receiving the schedule gift may be recorded and clipped in response to a timing of sending the scheduled gift is triggered.

In some embodiments, the best moment clip may be triggered automatically, manually or the like. In some embodiments, highlights of the best moment may be stored at the livestreamer side or shared with the sender of the schedule gift. According to the embodiments, the viewers may receive the gratitude from the livestreamer even if he or she is not in the live streaming room during the broadcasting.

In some embodiments, if the sender of the schedule gift is in the live streaming room, a special animation or marquee may also be displayed on the screen to notify the livestreamer and the other viewers. In some embodiments, if the sender could make it to the live streaming room and happened to enter the live streaming before the end of the broadcasting, a special entrance animation may also be displayed at the moment of the viewer entering the live streaming room to welcome the sender. According to the embodiments, the livestreamer may notice the presence of the sender and may show gratitude to the viewer directly.

In some embodiments, the gift may include different types of gift for the viewers to select and send. In some embodiments, a random gift may also be provided. Here, the random gift may refer to the gift that may generate random points compared with the original points of the random gift. For example, a random gift with the points of 1,000 may have the possibility of generating 100, 500, 1,000, 5,000, 10,000 or the like according to a random algorithm. According to the embodiments, the fun for sending gifts to the livestreamer may be improved.

In some embodiments, the gift may also be displayed on the screen 600 for the livestreamer to make an operation on it. For example, the gift may be displayed like a scratch card for the livestreamer to scratch and open the gift. In some embodiments, the gift may also be a series of gifts for the livestreamer to select. For example, more than one chests may be displayed on the screen 600 for the livestreamer to pick one or the like. In some embodiments, the gift may also be like a game for the livestreamer to play or the like. For example, the gift may be a little game such as whack-a-mole or NS-SHAFT or the like.

In some embodiments, the effects of the schedule gifts may be displayed for each schedule gift. In some embodiments, the effects may also be integrated into one or several effects to be displayed on the screen 600. For example, if the livestreamer receives three schedule gifts, three effects of the schedule gift may be displayed in order, or one effect indicating the receiving of the schedule gift may be displayed. According to the embodiments, the screen would not be bombarded with effects and the user experience may be improved.

In some embodiments, the entrance animation of the sender entering the live streaming room may be displayed each time the sender enters the live streaming room, or displayed once, for example, for the first time the sender enters the live streaming. According to the embodiments, the screen would not be bombarded with entrance animation and the user experience may be improved.

In some embodiments, the entrance animation may be triggered when the sender of the schedule gift enters the live streaming room. In some embodiments, the entrance animation may be triggered by the one who sends the schedule gift over a specific amount or number of schedule gifts. In some embodiments, the trigger of the entrance animation may be determined flexibly according to the practical need.

In some embodiments, extra reward may be distributed to the sender or the livestreamer if the sender sends the schedule gift and then joins the live streaming room afterward. The sender may send the schedule gift to the livestreamer if it could not make it to the schedule broadcasting or the like. However, if the sender can join the live streaming, the sender or the livestreamer may receive extra reward. For example, the value of some or all the schedule gifts may be increased by 1.2 times or the like. According to the embodiments, it may motivate the viewers to send the schedule gift to the livestreamer to support the live streaming, and the user experience may also be improved.

In some embodiments, if the broadcasting schedule is canceled or rescheduled by the livestreamer, the schedule gift may be returned to the viewer. In some embodiments, a message of “you have received some schedule gift, are you sure that you are going to cancel the broadcasting schedule” may be popped up to notify the livestreamer when the livestreamer is modifying or canceling the broadcasting schedule.

In some embodiments, instead of returning the schedule gift to the viewer, the schedule gift may also be kept in Server 10, and then notify the viewer whether to return the schedule gift, move to next broadcasting schedule or the like. In some embodiments, an in-app message or push notification may also be transmitted to the sender to notify the sender about the change of the broadcasting schedule. In some embodiments, Server 10 may also randomly or flexibly determine how to handle the schedule gift for the viewer. In some embodiments, the mechanism of the schedule gift may be determined flexibly according to the practical need.

In some embodiments, the information of the schedule gift may be displayed on the broadcasting schedule, personal profile or the like. In some embodiments, the information of the schedule gift may also be hidden or invisible to the livestreamer and the other viewers. In other words, only the sender may check the information of the schedule gift. According to the embodiments, the livestreamers may feel positively surprised when receiving the schedule gift in the live streaming, and the user experience may be improved.

In some embodiments, the broadcasting schedule may be determined by the livestreamer flexibly. For example, the livestreamer may set a description for the live streaming, an amount of points for participating the live streaming or the like. The livestreamer may also add a guest list in the broadcasting schedule. For example, if the livestreamer is going to broadcast with another livestreamers or have group broadcasting with other viewers, information of the livestreamers and viewers may also be listed at the guest list.

In some embodiments, a product list may also be added to the broadcasting schedule. For example, the livestreamer may add the products in the broadcasting schedule, and the products may be the products to be introduced and sold in the live streaming. In some embodiments, the livestreamer may also upload a file, such as a video, to promote the scheduled broadcasting. In some embodiments, promote materials generated by AI or machine learning model may also be provided automatically or manually to promote the scheduled broadcasting. In some embodiments, the livestreamer may add another broadcasting schedule to the current broadcasting schedule. The two or more broadcasting schedule may be from the same or different livestreamers. For example, the livestreamer may add another broadcasting schedule from another livestreamer who is going to broadcast with.

In some embodiments, the viewers may send schedule gift to the livestreamer via the broadcasting schedule in advance. In some embodiments, the viewers may register for the broadcasting schedule to indicate the participation to the live streaming or not. In some embodiments, the viewers may share, bookmark, add to favorite of the broadcasting schedule. In some embodiments, the viewers may also leave comments on the broadcasting schedule. For example, the viewers may ask questions, encouraging the livestreamer, supplement information to the broadcasting schedule.

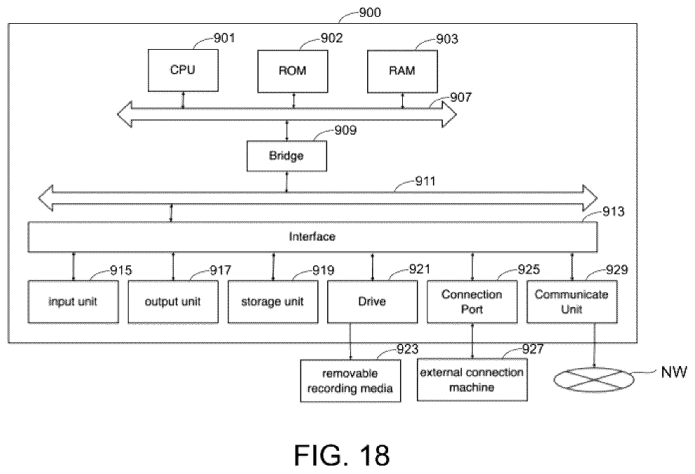

FIG. 18 is a schematic block diagram of computer hardware for carrying out a system configuration and processing according to some embodiments of subject application. The information processing device 900 in FIG. 18 is, for example, is configured to realize the server 10 and the user terminal 20, 30 respectively according to some embodiments of subject application.

The information processing device 900 includes a CPU 901, read only memory (ROM) 903, and random-access memory (RAM) 905. In addition, the information processing device 900 may include a host bus 907, a bridge 909, an external bus 911, an interface 913, an input unit 915, an output unit 917, a storage unit 919, a drive 921, a connection port 925, and a communication unit 929. The information processing device 900 may include imaging devices (not shown) such as cameras or the like. The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the streaming unit 100, the viewing unit 200, the video control unit 102, the audio control unit 104, the distribution unit 106, the UI control unit 108, the UI control unit 202, the rendering unit 204, the input transmit unit 206, the streaming info unit 302, the relay unit 304, the processing unit 306, the clip unit 308, the stream DB 320, the user DB 322, the AI V-Liver DB 324, the short-term memory DB 326, the long-term memory DB 328 and so on, may be embodied as circuitry programmed to realize such functions.

The CPU 901 functions as an arithmetic processing device and a control device, and controls the overall operation or a part of the operation of the information processing device 900 according to various programs recorded in the ROM 903, the RAM 905, the storage unit 919, or a removable recording medium 923. For example, the CPU 901 controls overall operations of respective function units included in the server 10 and the user terminal 20 and 30 of the above-described embodiment. The ROM 903 stores programs, operation parameters, and the like used by the CPU 901. The RAM 905 transiently stores programs used when the CPU 901 is executed, and parameters that change as appropriate when executing such programs. The CPU 901, the ROM 903, and the RAM 905 are connected with each other via the host bus 907 configured from an internal bus such as a CPU bus or the like. The host bus 907 is connected to the external bus 911 such as a Peripheral Component Interconnect/Interface (PCI) bus via the bridge 909.

The input unit 915 is a device operated by a user such as a mouse, a keyboard, a touchscreen, a button, a switch, and a lever. The input unit 915 may be a device that converts physical quantity to electrical signal such as audio sensor (such as microphone or the like), acceleration sensor, tilt sensor, infrared radiation sensor, depth sensor, temperature sensor, humidity sensor or the like. The input unit 915 may be a remote-control device that uses, for example, infrared radiation and another type of radio waves. Alternatively, the input unit 915 may be an external connection device 927 such as a mobile phone that corresponds to an operation of the information processing device 900. The input unit 915 includes an input control circuit that generates input signals on the basis of information which is input by a user to output the generated input signals to the CPU 901. The user inputs various types of data and indicates a processing operation to the information processing device 900 by operating the input unit 915.

The output unit 917 includes a device that can visually or audibly report acquired information to a user. The output unit 917 may be, for example, a display device such as an LCD, a PDP, and an OLED, an audio output device such as a speaker and a headphone, and a printer. The output unit 917 outputs a result obtained through a process performed by the information processing device 900, in the form of text or video such as an image, or sounds such as audio sounds.

The storage unit 919 is a device for data storage that is an example of a storage unit of the information processing device 900. The storage unit 919 includes, for example, a magnetic storage device such as a hard disk drive (HDD), a semiconductor storage device, an optical storage device, or a magneto-optical storage device. The storage unit 919 stores therein the programs and various data executed by the CPU 901, and various data acquired from an outside.

The drive 921 is a reader/writer for the removable recording medium 923 such as a magnetic disk, an optical disc, a magneto-optical disk, and a semiconductor memory, and built in or externally attached to the information processing device 900. The drive 921 reads out information recorded on the mounted removable recording medium 923, and outputs the information to the RAM 905. The drive 921 writes the record into the mounted removable recording medium 923.

The connection port 925 is a port used to directly connect devices to the information processing device 900. The connection port 925 may be a Universal Serial Bus (USB) port, an IEEE1394 port, or a Small Computer System Interface (SCSI) port, for example. The connection port 925 may also be an RS-232C port, an optical audio terminal, a High-Definition Multimedia Interface (HDMI (registered trademark)) port, and so on. The connection of the external connection device 927 to the connection port 925 makes it possible to exchange various kinds of data between the information processing device 900 and the external connection device 927.

The communication unit 929 is a communication interface including, for example, a communication device for connection to a communication network NW. The communication unit 929 may be, for example, a wired or wireless local area network (LAN), Bluetooth (registered trademark), or a communication card for a wireless USB (WUSB).

The communication unit 929 may also be, for example, a router for optical communication, a router for asymmetric digital subscriber line (ADSL), or a modem for various types of communication. For example, the communication unit 929 transmits and receives signals on the Internet or transmits signals to and receives signals from another communication device by using a predetermined protocol such as TCP/IP. The communication network NW to which the communication unit 929 connects is a network established through wired or wireless connection. The communication network NW is, for example, the Internet, a home LAN, infrared communication, radio wave communication, or satellite communication.

The imaging device (not shown) is a device that images real space using an imaging device such as a charge coupled device (CCD) or a complementary metal oxide semiconductor (CMOS), for example, and various members such as a lens for controlling image formation of a subject image on the imaging device and generates a captured image. The imaging device may capture a still picture or may capture a movie.

The present disclosure of the live streaming system 1 has been described with reference to embodiments. The above-described embodiments have been described merely for illustrative purposes. Rather, it can be readily conceived by those skilled in the art that various modifications may be made in making various combinations of the above-described components or processes of the embodiments, which are also encompassed in the technical scope of the present disclosure.

The procedures described herein, particularly flowchart or those described with a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

In some embodiments, at least a part of the functions performed by the server 10 may be performed by other than the server 10, for example, being performed by the user terminal 20 or 30. In some embodiments, at least a part of the functions performed by the user terminal 20 or 30 may be performed by other than the user terminal 20 or 30, for example, being performed by the server 10. In some embodiments, the rendering of the frame image may be performed by the user terminal 30 of the viewer, the server, the user terminal 20 of the livestreamer or the like.

Furthermore, the system and method described in the above embodiments may be provided with a computer-readable non-transitory storage device such as a solid-state memory device, an optical disk storage device, or a magnetic disk storage device, or a computer program product or the like. Alternatively, the programs may be downloaded from a server via the Internet.

Although technical content and features of the present disclosure are described above, a person having common knowledge in the technical field of the present disclosure may still make many variations and modifications without disobeying the teaching and disclosure of the present disclosure. Therefore, the scope of the present disclosure is not limited to the embodiments that are already disclosed but includes another variation and modification that do not disobey the present disclosure, and is the scope covered by the following patent application scope.

We claim:

1. A method, comprising:
receiving, from a user terminal, an instruction to use a virtual gift for a streamer before a live streaming of the streamer;
storing the instruction in a database;
retrieving, during the live streaming, the stored instruction in response to detecting the streamer's presence in the live streaming;
causing an output unit to output an animation effect corresponding to the virtual gift while the streamer is in the live streaming; and
transmitting a virtual points corresponding to the virtual gift to the streamer.

2. The method according to claim 1, wherein:
the output unit outputs the effect and points in response to a start of the live streaming from the streamer or a timing during the live streaming predetermined by the user.

3. The method according to claim 1, wherein:
the receiving includes receiving the instruction to use the gift while the user is viewing an broadcasting schedule or profile page of the streamer.

4. The method according to claim 1, wherein:
popularity of the live streaming is calculated according to the gift, and order of the live streaming at a live streaming page is determined according to the popularity.

5. The method according to claim 1, further comprising:
clipping a highlight of outputting the effect; and
forwarding the highlight to the user automatically or in response to a request from the streamer.

6. The method according to claim 1, wherein:
the use of the gift is set by the user to send to the streamer during a specific period or specific number of live streaming.

7. The method according to claim 1, wherein:
the output unit further outputs an animation corresponding to the user in response to participation by the user in the live streaming of the streamer.

8. The method according to claim 1, further comprising:
showing rankings on a display during the live streaming of the streamer; wherein
the rankings are based on an amount of gifts used or the number of times gifts are used by users for the streamer before the live streaming of the streamer.

9. A server comprising a circuitry, wherein the circuitry is configured to perform:
receiving, from a user terminal, an instruction to use a virtual gift for a streamer before a live streaming of the streamer;
storing the instruction in a database;
retrieving, during the live streaming, the stored instruction in response to detecting the streamer's presence in the live streaming; and
causing an output unit to output an animation effect corresponding to the virtual gift while the streamer is in the live streaming; and
transmitting a virtual points corresponding to the virtual gift to the streamer.

10. A non-transitory computer-readable medium including program instructions, that when executed by one or more processors, cause the one or more processors to execute:
receiving, from a user terminal, an instruction to use a virtual gift for a streamer before a live streaming of the streamer;
storing the instruction in a database;
retrieving, during the live streaming, the stored instruction in response to detecting the streamer's presence in the live streaming; and
causing an output unit to output an animation effect corresponding to the virtual gift while the streamer is in the live streaming; and
transmitting a virtual points corresponding to the virtual gift to the streamer.
